(19) United States
(12) Patent Application Publication
(10) Pub. No.: US 2024/0092198 A1
(43) Pub. Date: Mar. 21, 2024

(54) MULTI-VEHICLE CHARGING SYSTEM

(71) Applicant: Plug Zen, LLC, Grosse Pointe, MI (US)

(72) Inventor: KWABENA JOHNSON, Detroit, MI (US)

(73) Assignee: Plug Zen, LLC, Grosse Pointe, MI (US)

(21) Appl. No.: 18/038,294

(22) PCT Filed: Nov. 23, 2021
(86) PCT No.: PCT/US21/60453

§ 371 Date: May 23, 2023

Related U.S. Application Data
(60) Provisional application No. 63/116,979, filed on Nov. 23, 2020.

(51) Int. Cl. B60L 53/18; B60L 53/22; B60L 53/30; B60L 53/63

(52) U.S. Cl. CPC B60L 53/18; B60L 53/22; B60L 53/305; B60L 53/63

(57) ABSTRACT

A multi-vehicle charging system comprises a main station, including a power distribution module configured to receive power from a power grid and at least one main station charging port electrically coupled to the power distribution module for selectively receiving power therefrom. The system also includes at least one substation spaced apart from the main station and modularly coupled thereto. The at least one substation includes at least one substation charging port electrically coupled to the power distribution module of the main station for selectively receiving power therefrom. The system further includes at least one vehicle interface assembly having at least one plug, wherein the at least one plug is configured to selectively mate with each of the at least one main station charging port and the at least one substation charging port.

### PRIORITY

This application claims the benefit of U.S. Pat. App. No. 63/116,979, entitled “Multi-Vehicle Charging System,” filed Nov. 23, 2020, the disclosure of which is incorporated by reference herein.

### BACKGROUND

Electric vehicles (EVs) use one or more electric motors for propulsion. EVs are typically powered by one or more rechargeable batteries. Thus, EVs require charging systems (e.g., charging stations) for supplying electrical power to charge the batteries of EVs.

Major automobile manufacturers are committing to increasing production of EVs, such as by making EVs more than 25% of their vehicle platforms in coming years. However, public EV charging infrastructure is not large enough to support this growth. In addition, existing charging systems do not efficiently charge multiple EVs, which may be desirable in various locations such as multi-dwelling housing complexes, workplaces, public parks, mixed-use real estate, parking garages, surface lots, and/or fleet operations facilities, for example, or any other location where multiple EVs may be parked for a threshold amount of time sufficient to allow full EV charging (e.g., 2 hours). Charging systems are also typically expensive, with high costs incurred by both consumers (e.g., EV owners/drivers) and charging system stakeholders (e.g., charging system/property owners), thereby making them cost-prohibitive in many cases.

While several systems and methods have been made and used for charging EVs, it is believed that no one prior to the inventors has made or used the invention described in the appended claims.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 depicts a schematic view of an exemplary multi-vehicle charging system;

FIG. 2 depicts a schematic front view of a main charging station of the system of FIG. 1;

FIG. 3 depicts a schematic rear view of the main station of FIG. 2;

FIG. 4 depicts a schematic side view of the main station of FIG. 2;

FIG. 5 depicts a schematic view of various internal components of the main station of FIG. 2;

FIG. 6 depicts a schematic view of an exemplary wired vehicle interface assembly for use with the system of FIG. 1; and

FIG. 7 depicts a schematic view of an exemplary wireless vehicle interface assembly for use with the system of FIG. 1.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain aspects of the invention should not be used to limit the scope of protection provided by this document or any related document. Other aspects, features, advantages of the disclosed technology will become apparent to those skilled in the art from the following description, which is by way of illustration, one of the best modes contemplated for practicing the disclosed technology. As will be realized, the disclosed technology is capable of other different and obvious aspects, all without departing from the scope of what could be implemented by one of ordinary skill in the art without undue experimentation based on this disclosure or of what this disclosure would convey to one of ordinary skill in the art has been invented. Accordingly, the descriptions should be regarded as illustrative in nature and not restrictive.

Furthermore, the terms “about,” “approximately,” and the like as used herein in connection with any numerical values or ranges of values are intended to encompass the exact value(s) referenced as well as a suitable tolerance that enables the referenced feature or combination of features to function for the described purpose.

### I. OVERVIEW

The present disclosure relates to systems and methods for charging multiple electrical vehicles, including a multi-vehicle charging system (MVCS) for 20-amp, 40-amp, or other power supply that can be expanded to charge up to 4 or more vehicles. For example, in one aspect of the present disclosure, a modular electric vehicle charging system can simultaneously charge 2 vehicles or be expanded to charge additional vehicles. The system comprises 2 components: The main station; the primary charging unit (PCU), and the sub charging units (SCU). EV drivers will be able to use this system either through portable or detachable wired or wireless charging devices that utilize standard wall plugs, through auxiliary on-board charging systems with cords that extend from the vehicle and plug into the charger, or with cables and connectors extending from the charger to the vehicle, as will be understood by those skilled in the art. The system will charge vehicles in a range of 20 amps (level 1) and 40 amps (level 2). This system is designed to be mounted on the floor, wall, or posts—anywhere there is an electrical supply circuit. It is ideal for use in parking garages and surface lots.

The PCU houses a single-board computer, a wireless network control module, main breaker and remote breakers, and a switch that energizes the individual circuits (charge ports), which in this example are spaced 5 feet apart. The outlets in this example will be capable of charging vehicles at the level 1 and 2 charging protocols. The PCU will have the capacity to house multiple circuits of varying voltages (110, 220, etc.) and stacking them. The system's expansion capacity is based on the amount of power available from the power supply and the circuits in the PCU.

Inside the Gen 1 PCU is a single board computer and a communications device that communicates with one or more of the utility power grid (e.g., a “smart grid”), the station owner, the EV driver, and/or a valet parking service.

The station could offer free charging or paid charging, also known as “charge as a service” (CaaS)-based. When the station is CaaS, the EV driver scans a QR code or RFID credit card reader located on the front of the detachable charging device they wish to charge their vehicle from. Once the code or card is scanned, the user will be directed to the server to arrange payment. Once the payment is accepted, a signal is sent from a centralized server to the PCU to energize that particular charge port being selected. In other implementations, other techniques will communicate to the system that the EV (or EV driver) is ready to use the system, such as by way of a mobile app, wireless identifier, and NFC communication, or the like. Generation 2 MVCS detachable devices will communicate directly with the server for payment arrangement and activation.

The system is capable of expanding by attaching a substation to the main station. Additional substations can be added (or stacked) to the system by attaching them to the end of last substation connected to the system. In other implementations, additional substations are connected directly to the main station.

The illustrated implementation of the system gives the property owner, employer, or other implementer the ability to provide level 2 or level 3 vehicle charging (depending on voltage or current capacity) for their tenants, employees, associates, or customers with options for free charging without smart grid, free charging with smart grid, and/or CaaS through an app or website.

### II. EXEMPLARY MULTI-VEHICLE CHARGING SYSTEM

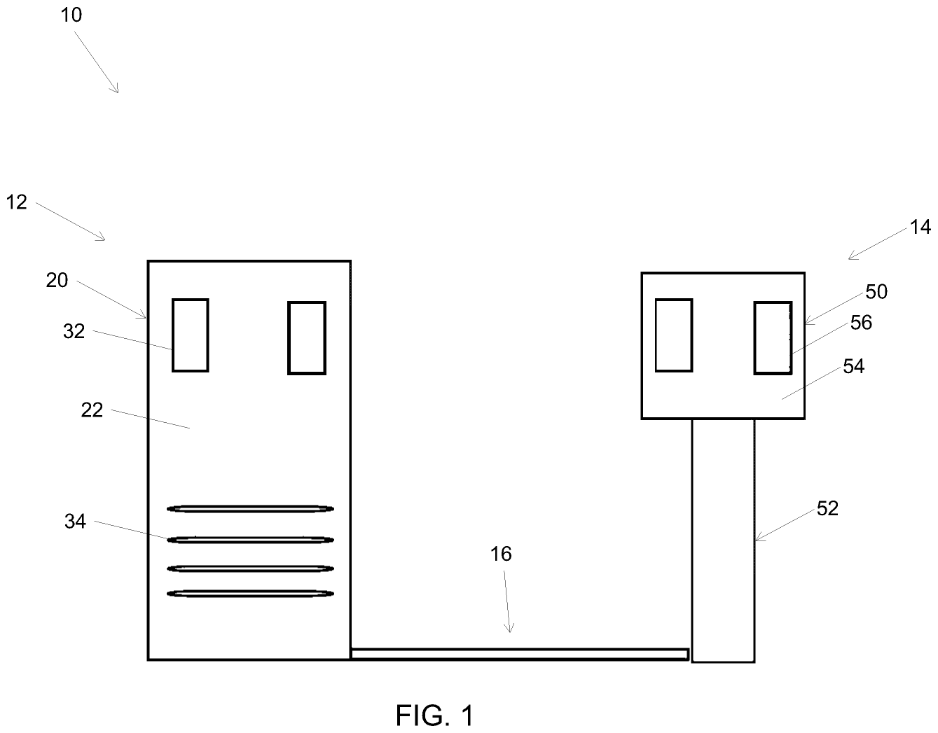

FIGS. 1-7 depict an exemplary multi-vehicle charging system (10). In the example shown, the system (10) includes a main station (also referred to as a master station, a hub station, and/or a primary charging unit (PCU)) (12) electrically coupled to one or more substation(s) (also referred to as a slave station(s), a satellite station(s), and/or a sub charging unit(s) (SCUs)) (14) via one or more corresponding conduit(s) (16). While a single substation (14) is shown, it will be appreciated that system (10) may include any suitable number of substations (14), such as between one and four substations (14), in a single installation. For example, system (10) may include four substations (14). In some versions, substations (14) may be selectively coupled to and/or selectively decoupled from main station (12), to thereby provide modularity to system (10). In this regard, the number of substations (14) may be selected to enable system (10) to charge a predetermined number of EVs, such that system (10) may be customizable to meet a particular demand. For example, system (10) may initially include main station (12) and a single substation (14) coupled thereto via a corresponding conduit (16) and may subsequently be expanded via the addition of another substation (14) coupled to main station (12) via another conduit (16) to increase the EV charging capabilities of system (10). In some cases, a first substation (14) may be directly coupled to main station (12) via a corresponding conduit (16), and a second substation (14) may be directly coupled to the first substation (14) via a corresponding conduit (16) such that the second substation (14) may be indirectly coupled to main station (12) via the first substation (14).

In any event, each substation (14) may be spaced apart from main station (12) and/or from each other substation(s) (14) by a sufficient distance to fit one or more EVs therebetween. In some versions, each substation (14) may be spaced apart from main station (12) and/or from another substation(s) (14) by a distance of between about 5 feet and about 10 feet. For example, each substation (14) may be spaced apart from main station (12) and/or from another substation(s) (14) by a distance of about 5 feet or about 10 feet. In some versions, the substations (14) are oriented in parallel, while in others the substations (14) are oriented in different directions to accommodate more substations (14), better use space, or achieve other design goals as will occur to those skilled in the art in view of this disclosure.

Main station (12) of the present version includes a main station housing (20). In the example shown, main station housing (20) includes a front panel (22), an upper rear panel (also referred to as an access panel) (24), a lower rear panel (26), and a pair of side panels (28) coupled to each other to at least partially define an interior cavity (30) of main station housing (20). While not shown, main station housing (20) may also include a top panel and/or a bottom panel coupled to any one or more of panels (22, 24, 26, 28) for further defining interior cavity (30).

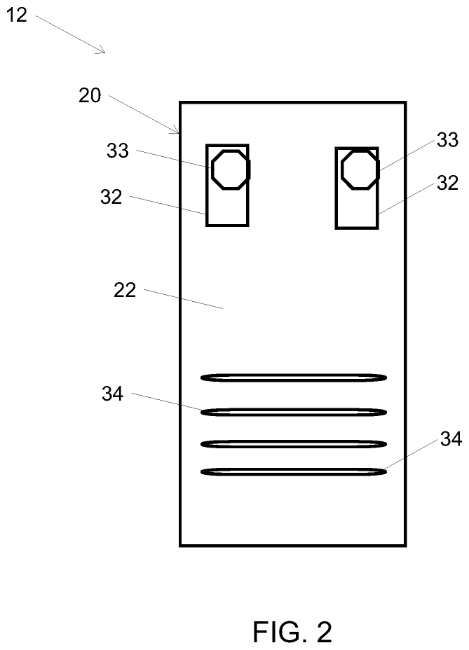

As best shown in FIG. 2, front panel (22) of the present example includes a pair of upper slots (32) generally aligned with respective charging ports (33) such that charging ports (33) are each accessible from an exterior of main station housing (20) via the respective upper slots (32). Charging ports (33) are each configured to removably receive a respective plug for charging a respective EV vehicle, as described in greater detail below. In some versions, each charging port (33) may include a NEMA 6-50 receptacle. In any event, the illustrated front panel (22) also includes a plurality of lower air vents (34) for facilitating cooling of various electrical and telecommunications components positioned within interior cavity (30) of main station housing (20). In some versions, front panel (22) may have a height of about 60 inches, a width of about 36 inches, and/or a thickness of about 2 inches. In addition, or alternatively, upper slots (32) may each have a height of about 6 inches, a width of about 2 inches, and/or a depth of about 2 inches.

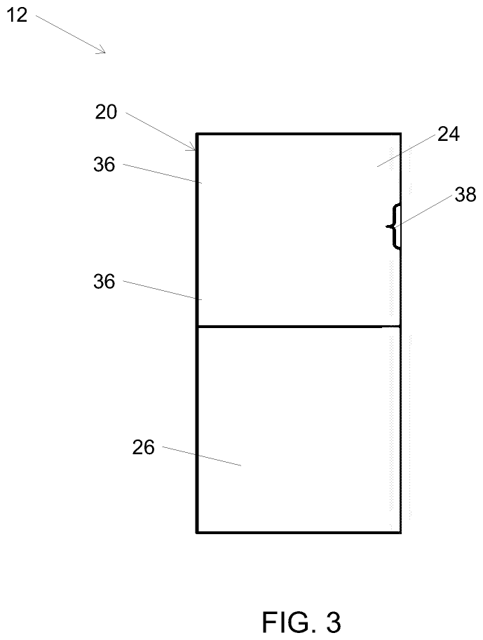

As best shown in FIG. 3, upper rear panel (24) of the present example is pivotably coupled to one of the pair of side panels (28) via a pair of hinges (36) such that upper rear panel (24) may be selectively pivoted relative to the one of the pair of side panels (28) between open and closed positions for respectively permitting and restricting access to interior cavity (30) from an exterior of main station housing (20). To that end, the illustrated upper rear panel (24) includes a handle (38) for providing a grippable lever and/or surface to assist with pivoting of upper rear panel (24) between the open and closed positions by a user. Handle (38) may be keyed such that handle (38) may be selectively locked and unlocked for respectively securing upper rear panel (24) in the closed position and permitting pivoting of upper rear panel (24) away from the closed position. In some versions, upper rear panel (24) and lower rear panel (26) may each have a width of about 36 inches and/or a thickness of about 2 inches. In addition, or alternatively, upper rear panel (24) and lower rear panel (26) may have respective heights that collectively amount to about 60 inches. For example, upper rear panel (24) and lower rear panel (26) may each have a height of about 30 inches.

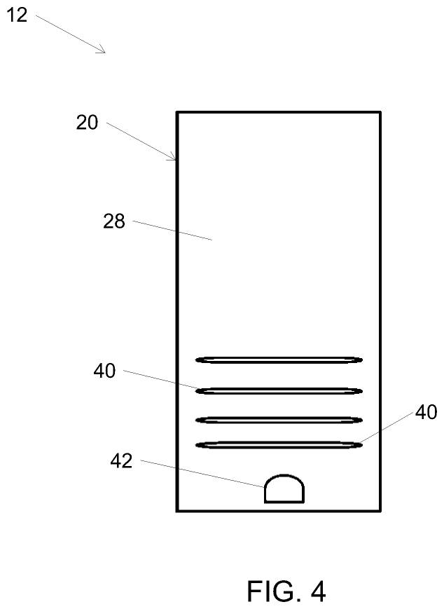

As best shown in FIG. 4, each side panel (28) of the present example includes a plurality of lower air vents (40) for facilitating cooling of various electrical and telecommunications components positioned within interior cavity (30) of main station housing (20), and an aperture (42) positioned below air vents (40) for receiving a corresponding conduit (16). While aperture (42) is described as being present in both side panels (28), aperture (42) may be present in only one side panel (28) and omitted from the other side panel (28). In some versions, each side panel (28) may have a height of about 60 inches, a width of about 24 inches, and/or a thickness of about 2 inches.

Referring again primarily to FIG. 1, each substation (14) of the present version includes a substation housing (50) supported by a post, such as a bollard (52). In the example shown, substation housing (50) includes a front panel (54). While not shown, substation housing (50) may also include a rear panel, a pair of side panels, a top panel, and/or a bottom panel coupled to each other to at least partially define an interior cavity of substation housing (50).

As shown, front panel (54) of the present example includes a pair of slots (56) generally aligned with respective charging ports (33) such that charging ports (33) are each accessible from an exterior of substation housing (50) via the respective slots (56). Charging ports (33) are each configured to removably receive a respective plug for charging a respective EV vehicle, as described in greater detail below. In some versions, each charging port (33) may include a NEMA 6-50 receptacle, while other versions may include more or different kinds of receptacle. In some versions, front panel (54) may have a width of about 24 inches and/or a thickness of about 2 inches. In addition, or alternatively, front panel (54) and bollard (52) may have respective heights that collectively amount to about 60 inches. In addition, or alternatively, slots (56) may each have a height of about 6 inches, a width of about 2 inches, and/or a depth of about 2 inches.

As shown, each conduit (16) extends from a respective substation (14) to main station (12) and into interior cavity (30) via a respective aperture (42) for electrically coupling the respective substation (14) to main station (12). In some versions, conduit (16) may have a length of between about 5 feet and about 10 feet. For example, conduit (16) may have a length of about 5 feet or about 10 feet. In addition, or alternatively, conduit (16) may have a cross dimension (e.g., diameter) of about 1 inch. It will be appreciated that conduit (16) may have any suitable cross dimension for routing electrical wires between main station (12) and the respective substation (14).

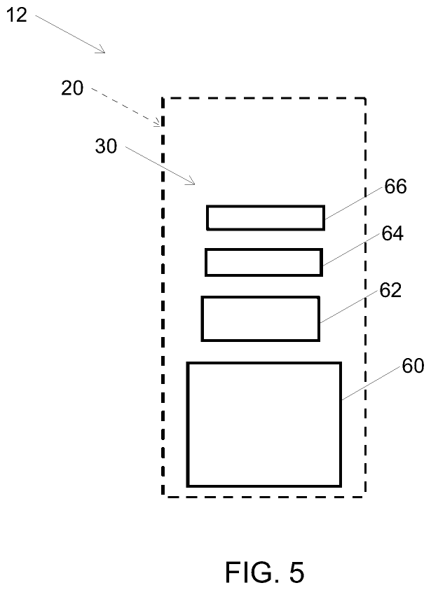

Referring now to FIG. 5, main station (12) of the present version further includes a plurality of electrical and telecommunications components positioned within interior cavity (30) of main station housing (20) and collectively defining a power distribution module of main station (12). In the example shown, main station (12) includes a power converter in the form of a transformer (60), a circuit breaker panel (62) (including various breakers such as a 480 A breaker and/or a plurality of 40 A RS 485 breakers), a voltage meter (also referred to as a load meter or a circuit meter) (64), and a processor (e.g., single board computer) with an onboard modem (e.g., LTE or 5G) and antenna (66), which are configured to cooperate with each other to selectively deliver power from a utility power grid to each of charging ports (33) via respective circuits. For example, processor (66) may be configured to receive a wireless request signal from a server requesting power delivery to a selected charging port (33), and to send an activation signal to a selected breaker within circuit breaker panel (62) that is associated with the selected charging port (33) (e.g., via an RS 485 switch), and the selected breaker may be configured to close the respective circuit from transformer (60) to the selected charging port (33) to thereby deliver power to the selected charging port (33). In this regard, transformer (60) may be sized and configured to be capable of supplying sufficient power to charge multiple EVs simultaneously via respective charging ports (33). For example, transformer (60) may include a 110 kilovolt-amperes (kVA) transformer. Thus, power may be delivered to any charging port(s) (33) via centralized switching at main station (12).

In some versions, the power input of main station (12) from the utility power grid may be 240 or 120 VAC 400 A. In such cases, 80 A may be delivered to charging ports (33) altogether, with 40 A being delivered to each charging port (33). In addition, or alternatively, up to 320 A may be delivered to charging ports (33) altogether. For example, 80 A may be delivered to the combined charging ports (33) of each substation (14), with 40 A being delivered to each charging port (33) of each substation (14). This may be the case when four substations (14) are electrically coupled to main station (12), for example. More particularly, a total of five stations (12, 14) may provide a total of ten charging ports (33) with respective circuits for recharging a total of ten EVs simultaneously at the rate of 240 or 120 VAC 40 A via the corresponding charging ports (33). In some versions, an alternating current switch may be incorporated into main station (12) for determining which of the EVs that are recharging requires the most amount of charging (e.g., based on vehicle battery status), and/or for opening and closing breakers within circuit breaker panel (62) based on the number of EVs that are recharging and vehicle demands.

In other versions, the power input of main station (12) from the utility power grid may be 480 VAC 400 A. In such cases, transformer (60) may step down the voltage to 240 VA and induce sufficient current and voltage to simultaneously feed 8 circuits at 240 VAC 40 A. Transformer (60) may send current to a main 480 A breaker circuit, which may in turn send current to the individual 40 A circuit breakers, which may open and close based on signals received from processor (66).

It will be appreciated that by utilizing the power distribution module (e.g., transformer (60), circuit breaker panel (62), voltage meter (64), and integrated SBC and modem (66)) of main station (12) to regulate power delivery to both main station (12) and substation(s) (14), the configuration of substation(s) (14) may be substantially simplified, at least by comparison to alternative configurations of substations having dedicated power distribution modules.

Various types of plugs may be removably received by each charging port (33). In this regard, each charging port (33) may be configured to removably receive a plug that is directly integrated into an end user's portable charger. In addition, or alternatively, each charging port (33) may be configured to removably receive a plug of any suitable type of vehicle interface assembly for charging an EV having a compatible interface protocol, and or each charging port (33) may be configured with one or more cables, plugs, and/or ports to provide connections to EVs that use particular standards.

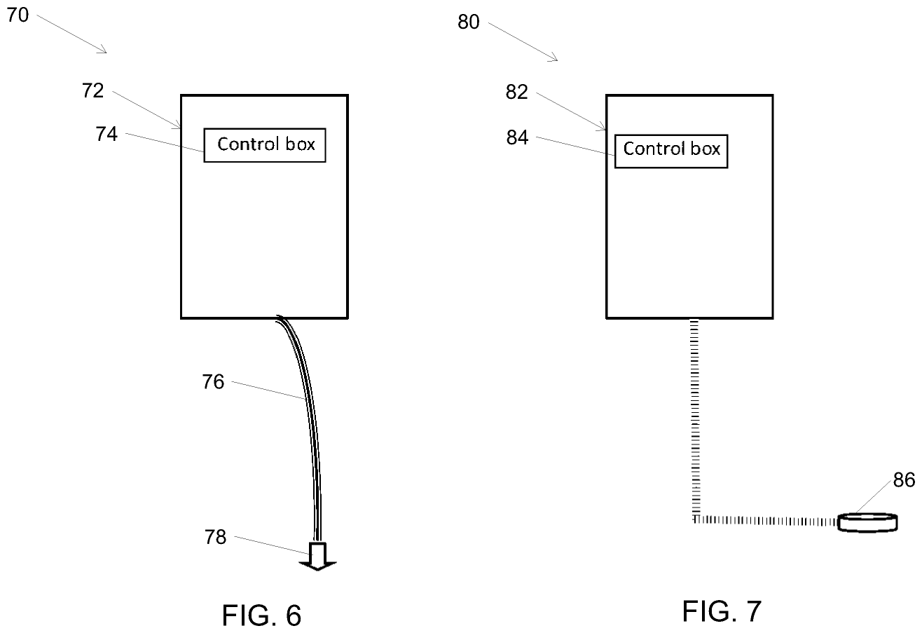

Referring now to FIG. 6, in some versions, system (10) includes a wired vehicle interface assembly (70). In the example shown, wired vehicle interface assembly (70) includes a plug (72) having an integrated control box (74) and further includes a cable (76) extending from plug (72) to a connector in the form of an SAE J1772 connector (78). Plug (72) may be configured to be removably received by any one or more of charging ports (33) and/or to be physically supported within the corresponding slot (32, 56). In this regard, plug (72) may have dimensions similar to those of any one or more of slots (32, 56) for secure receipt thereby. For example, plug (72) may have a height of about 6 inches and/or a width of about 2 inches. In some versions, cable (76) may have a length of between about 10 feet and about 15 feet. In any event, control box (74) of plug (72) may include various electronics for facilitating data wire or wireless communication with main station (12), electric metering, and/or smart vehicle interactivity. Thus, wired vehicle interface assembly (70) may enable charging of EVs having SAE J1772 interfaces via any one or more of charging ports (33).

Referring now to FIG. 7, in some versions, system (10) includes a wireless vehicle interface assembly (80). In the example shown, wireless vehicle interface assembly (80) includes a plug (82) having an integrated control box (84) and further includes a wireless charge pad (86). Plug (82) may be configured to be removably received by any one or more of charging ports (33) and/or to be physically supported within the corresponding slot (32, 56). In this regard, plug (82) may have dimensions similar to those of any one or more of slots (32, 56) for secure receipt thereby. For example, plug (82) may have a height of about 6 inches and/or a width of about 2 inches. In any event, control box (84) of plug (82) may include various electronics for facilitating wired or wireless data communication with main station (12), electric metering, and/or smart vehicle interactivity. Thus, wireless vehicle interface assembly (80) may enable charging of EVs having wireless induction interface protocols via any one or more of charging ports (33).

During operation, a user may park the user's EV adjacent to a selected station (12, 14) and may initiate a request to begin charging the EV via a selected charging port (33) of the selected station (12, 14). In some versions, the user may initiate such a request by scanning a machine-readable optical label (e.g., a QR code) associated with the selected charging port (33) via the user's mobile device (e.g., smartphone), which may direct the user to a website or mobile app to complete the request by arranging mobile payment (e.g., via a payment app, prepaid account, or credit card) or automatically proceed using prearranged payment information. In response to completion of the request, a server may send a request signal to processor (66) of main station (12) requesting power delivery to the selected charging port (33). In response to receiving the request signal, processor (66) may activate (e.g., energize) the selected charging port (33) of the selected station (12, 14) by switching breakers or other power switches within main station (12) that connect power from transformer (60) to the selected charging port (33), thereby enabling the user to recharge the EV via the selected charging port (33) and an appropriate interface protocol. In some versions, voltage meter (64) (and/or a load meter of control box (74, 84), if used) may monitor the amount of power supplied to the EV and may send a completion signal to the server in response to the EV being fully recharged. The server may transmit power usage data (e.g., continuously in real-time) and/or payment (e.g., upon charge completion) to the utility company that maintains the utility power grid for monitoring system (10) to determine demand levels. In cases of over-demand, the utility company may restrict demand by lowering the voltage or by opening the circuit for the selected charging port (33) to cease/interrupt recharging of the EV. In any event, the server may send a wireless signal to the user's mobile device to indicate charge completion or charge interruption due to over demand.

### III. EXEMPLARY COMBINATIONS

Aspect 1: A multi-vehicle charging system comprising: (a) a main station including: (i) a power distribution module configured to receive power from a power grid, and (ii) at least one main station charging port electrically coupled to the power distribution module for selectively receiving power therefrom; (b) at least one substation spaced apart from the main station and modularly coupled thereto, wherein the at least one substation includes at least one substation charging port electrically coupled to the power distribution module of the main station for selectively receiving power therefrom; and (c) at least one vehicle interface assembly having at least one plug, wherein the at least one plug is configured to selectively mate with each of the at least one main station charging port and the at least one substation charging port.

Aspect 2: The system of Aspect 1, wherein the power distribution module is configured to independently activate each of the at least one main station charging port and the at least one substation charging port.

Aspect 3: The system of Aspect 2, wherein the power distribution module is in operative communication with a server, wherein the power distribution module is configured to independently activate each of the at least one main station charging port and the at least one substation charging port in response to receiving a corresponding activation request signal from the server.

Aspect 4: The system of any one or more of the preceding Aspects, wherein the at least one main station charging port includes a pair of main station charging ports.

Aspect 5: The system of any one or more of the preceding Aspects, wherein the at least one substation charging port includes a pair of substation charging ports.

Aspect 6: The system of any one or more of the preceding Aspects, wherein the at least one charging substation comprises a plurality of substations.

Aspect 7: The system of Aspect 6, wherein the plurality of substations comprises four sub stations.

Aspect 8: The system of any one or more of Aspects 6 through 7, wherein one substation of the plurality of substations is modularly coupled to the main station via another substation of the plurality of substations.

Aspect 9: The system of any one or more of the preceding Aspects, wherein at least one of the at least one main station charging port or the at least one substation charging port comprises a NEMA 6-50 receptacle.

Aspect 10: The system of any one or more of the preceding Aspects, wherein the power distribution module comprises: (A) a transformer configured to receive power from the power grid, (B) a plurality of power switches configured to selectively open and close respective circuits between the transformer and each of the at least one main station charging port and the at least one substation charging port, and (C) a processor configured to send control signals to each power switch of the plurality of power switches.

Aspect 11: The system of any one or more of the preceding Aspects, wherein the at least one substation is spaced apart from the main station by a predetermined distance sufficient to receive a vehicle.

Aspect 12: The system of Aspect 11, wherein the predetermined distance is between about 5 feet and about 10 feet.

Aspect 13: The system of any one or more of the preceding Aspects, wherein the at least one vehicle interface assembly includes: (i) a first vehicle interface assembly having a first plug, wherein the first plug is configured to selectively mate with each of the at least one main station charging port and the at least one substation charging port, wherein the first vehicle interface assembly is compatible with a first vehicle interface protocol, and (ii) a second vehicle interface assembly having a second plug, wherein the second plug is configured to selectively mate with each of the at least one main station charging port and the at least one substation charging port, wherein the second vehicle interface assembly is compatible with a second vehicle interface protocol different from the first vehicle interface protocol.

Aspect 14: The system of Aspect 13, wherein the first vehicle interface assembly includes an SAE J1772 plug operatively coupled to the first plug.

Aspect 15: The system of Aspect 14, wherein the second vehicle interface assembly includes a wireless charge pad operatively coupled to the second plug.

Aspect 16: A multi-vehicle charging system comprising: (a) a main station including: (i) a power distribution module configured to receive power from a power grid, and (ii) a pair of main station charging ports electrically coupled to the power distribution module for selectively receiving power therefrom; (b) a plurality of substations each spaced apart from the main station and modularly coupled thereto, wherein each substation of the plurality of substations includes a pair of substation charging ports electrically coupled to the power distribution module of the main station for selectively receiving power therefrom; (c) a first vehicle interface assembly having a first plug, wherein the first plug is configured to selectively mate with each main station charging port of the pair of main station charging ports and each substation charging port of the pair of substation charging ports, wherein the first vehicle interface assembly is compatible with a first vehicle interface protocol; and (d) a second vehicle interface assembly having a second plug, wherein the second plug is configured to selectively mate with each main station charging port of the pair of main station charging ports and each substation charging port of the pair of substation charging ports, and wherein the second vehicle interface assembly is compatible with a second vehicle interface protocol different from the first vehicle interface protocol.

Aspect 17: The system of Aspect 16, wherein the power distribution module is configured to independently activate each main station charging port of the pair of main station charging ports and each substation charging port of the pair of substation charging ports.

Aspect 18: The system of any one or more of Aspects 16 through 17, wherein the plurality of substations comprises four substations.

Aspect 19: The system of any one or more of Aspects 16 through 18, wherein the first vehicle interface assembly includes an SAE J1772 plug operatively coupled to the first plug, wherein the second vehicle interface assembly includes a wireless charge pad operatively coupled to the second plug.

Aspect 20: A method of charging multiple vehicles via a charging system, the system including a main station having a first charging port and a substation spaced apart from the main station and having a second charging port, the method comprising: (a) operatively coupling a first vehicle battery to the first charging port via a wired vehicle interface assembly; (b) operatively coupling a second vehicle battery to the second charging port via a wireless vehicle interface assembly; (c) activating the first charging port via a power distribution module of the main station to thereby deliver power to the first vehicle via the wired vehicle interface assembly; and (d) while delivering power to the first vehicle, activating the second charging port via the power distribution module of the main station to thereby deliver power to the second vehicle via the wireless vehicle interface assembly

### IV. MISCELLANEOUS

It should be understood that any of the aspects described herein may be combined with other aspects described herein and may include various other features in addition to or in lieu of those described above.

It should be understood that any one or more of the teachings, expressions, embodiments, examples, etc. described herein may be combined with any one or more of the other teachings, expressions, embodiments, examples, etc. that are described herein. The above-described aspects, teachings, expressions, embodiments, examples, etc. should, therefore, not be viewed in isolation relative to each other. Various suitable ways in which the teachings herein may be combined will be readily apparent to those of ordinary skill in the art in view of the teachings herein. Such modifications and variations are intended to be included within the scope of protection provided by this document.

Having shown and described various versions of the inventor's technology, further adaptations of the methods and systems described herein may be accomplished by appropriate modifications by one of ordinary skill in the art without departing from the scope of the present disclosure. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of protection provided by this document, or by other related documents should be considered in terms of the document's claims and should not be limited to the details of structure and operation shown and described in the specification and drawings.

I/We claim:

1. A multi-vehicle charging system comprising:
(a) a main station, including:
(i) a power distribution module configured to receive power from a power grid, and
(ii) at least one main station charging port electrically coupled to the power distribution module for selectively receiving power therefrom;
(b) at least one substation spaced apart from the main station and modularly coupled thereto, wherein the at least one substation includes at least one substation charging port electrically coupled to the power distribution module of the main station for selectively receiving power therefrom; and
(c) at least one vehicle interface assembly having at least one plug, wherein the at least one plug is configured to selectively mate with each of the at least one main station charging port and the at least one substation charging port.

2. The system of claim 1, wherein the power distribution module is configured to independently activate each of the at least one main station charging port and the at least one substation charging port.

3. The system of claim 2, wherein the power distribution module is in operative communication with a server, wherein the power distribution module is configured to independently activate each of the at least one main station charging port and the at least one substation charging port in response to receiving a corresponding activation request signal from the server.

4. The system of claim 1, wherein the at least one main station charging port includes a pair of main station charging ports.

5. The system of claim 1, wherein the at least one substation charging port includes a pair of substation charging ports.

6. The system of claim 1, wherein the at least one charging substation comprises a plurality of substations.

7. The system of claim 6, wherein the plurality of substations comprises four substations.

8. The system of claim 6, wherein one substation of the plurality of substations is modularly coupled to the main station via another substation of the plurality of substations.

9. The system of claim 1, wherein at least one of the at least one main station charging port or the at least one substation charging port comprises a NEMA 6-50 receptacle.

10. The system of claim 1, wherein the power distribution module comprises:
(A) a transformer configured to receive power from the power grid,
(B) a plurality of power switches configured to selectively open and close respective circuits between the transformer and each of the at least one main station charging port and the at least one substation charging port, and
(C) a processor configured to send control signals to each power switch of the plurality of power switches.

11. The system of claim 1, wherein the at least one substation is spaced apart from the main station by a predetermined distance sufficient to receive a vehicle.

12. The system of claim 11, wherein the predetermined distance is between about 5 feet and about 10 feet.

13. The system of claim 1, wherein the at least one vehicle interface assembly includes:
(i) a first vehicle interface assembly having a first plug, wherein the first plug is configured to selectively mate with each of the at least one main station charging port and the at least one substation charging port, wherein the first vehicle interface assembly is compatible with a first vehicle interface protocol, and
(ii) a second vehicle interface assembly having a second plug, wherein the second plug is configured to selectively mate with each of the at least one main station charging port and the at least one substation charging port, wherein the second vehicle interface assembly is compatible with a second vehicle interface protocol different from the first vehicle interface protocol.

14. The system of claim 13, wherein the first vehicle interface assembly includes an SAE J1772 plug operatively coupled to the first plug.

15. The system of claim 14, wherein the second vehicle interface assembly includes a wireless charge pad operatively coupled to the second plug.

16. A multi-vehicle charging system comprising:
(a) a main station including:
(i) a power distribution module configured to receive power from a power grid, and
(ii) a pair of main station charging ports electrically coupled to the power distribution module for selectively receiving power therefrom;
(b) a plurality of substations each spaced apart from the main station and modularly coupled thereto, wherein each substation of the plurality of substations includes a pair of substation charging ports electrically coupled to the power distribution module of the main station for selectively receiving power therefrom;
(c) a first vehicle interface assembly having a first plug, wherein the first plug is configured to selectively mate with each main station charging port of the pair of main station charging ports and each substation charging port of the pair of substation charging ports, wherein the first vehicle interface assembly is compatible with a first vehicle interface protocol; and
(d) a second vehicle interface assembly having a second plug, wherein the second plug is configured to selectively mate with each main station charging port of the pair of main station charging ports and each substation charging port of the pair of substation charging ports, and wherein the second vehicle interface assembly is compatible with a second vehicle interface protocol different from the first vehicle interface protocol.

17. The system of claim 16, wherein the power distribution module is configured to independently activate each main station charging port of the pair of main station charging ports and each substation charging port of the pair of substation charging ports.

18. The system of claim 16, wherein the plurality of substations comprises four substations.

19. The system of claim 16, wherein the first vehicle interface assembly includes an SAE J1772 plug operatively coupled to the first plug, wherein the second vehicle interface assembly includes a wireless charge pad operatively coupled to the second plug.

20. A method of charging multiple vehicles via a charging system, the system including a main station having a first charging port and a substation spaced apart from the main station and having a second charging port, the method comprising:
(a) operatively coupling a first vehicle battery to the first charging port via a wired vehicle interface assembly;
(b) operatively coupling a second vehicle battery to the second charging port via a wireless vehicle interface assembly;
(c) activating the first charging port via a power distribution module of the main station to thereby deliver power to the first vehicle via the wired vehicle interface assembly; and
(d) while delivering power to the first vehicle, activating the second charging port via the power distribution module of the main station to thereby deliver power to the second vehicle via the wireless vehicle interface assembly.
